(19) United States
(12) Patent Application Publication
(10) Pub. No.: US 2006/0161613 A1
(43) Pub. Date: Jul. 20, 2006

(54) Method and apparatus for arithmatic operation of processor

(75) Inventor: Chul Jae Yoo, Gyeonggi-do (KR)

Correspondence Address: LEE, HONG, DEGERMAN, KANG & SCHMADEKA;14th Floor, 801 S. Figueroa Street, Los Angeles, CA, 90017, US

(73) Assignee: LG Electronics Inc.

(21) Appl. No.: 11/317,108

(22) Filed: Dec. 22, 2005

(30) Foreign Application Priority Data
Jan. 5, 2005 (KR) 10-2005-758

(51) Int. Cl. G06F 7/52

(52) U.S. Cl. 708/650

(57) ABSTRACT

A method and apparatus for arithmetic operation of a processor are disclosed. The method and apparatus divide operands whose wordlength is greater than the wordlength which can be processed by a processor once into wordlengths which can be processed by the processor and then perform operations therebetween. The method and apparatus can perform addition, subtraction and multiplication of an operand whose wordlength is greater than the wordlength which can be processed by a processor at once without loss of information.

This application claims the benefit of Korean Patent Application No. 10-2005-0000758, filed on Jan. 5, 2005, which is hereby incorporated by reference as if fully set forth herein.

### BACKGROUND OF THE INVENTION

1. Field of the Invention

The present invention relates to a method and apparatus for arithmetic operation of a processor, and more particularly, to a method and apparatus for arithmetic operation of a processor which is capable of efficiently operating an operand which has a relatively long word length.

2. Discussion of the Related Art

A processor is a key operation apparatus in digital signal processing technology. Recently, since most information, such as images, voice, characters, etc., is processed after the information is converted to digital signals, such a processor as an arithmetic operation apparatus processing digital signals are performing a wider variety of functions.

The processors are classified into a universal microprocessor functioning as a universal CPU, such as a reduced instruction set computer (RISC), and a digital signal processor which is specialized in specific digital signal processes. However, these processors have a common structure for primary parts thereof, such as an arithmetic and logic unit (ALU), an address generator, a memory unit and a bus.

Especially, the ALU performs operations based on the least unit for processing digital signals. In general, the ALU has a pipeline structure, such that one operation result per cycle of operation frequency can be produced.

When the ALU produces its operation result, a wordlength processed by the processor is an important factor such that it can determine bit resolution of a processor.

When a wordlength that a processor can process is determined, operation of the ALU for an operand can be processed by the determined wordlength. If there is data over the wordlength, truncation or rounding off is applied to the data such that the wordlength is limited.

Such a method brings about loss of processing information. Here, if an error according to loss of information is relatively small, the information can be used.

However, since entropy coding performs lossless coding, if even one bit is wrongly processed, encoding or decoding cannot be performed.

Recently, portable apparatuses, which are capable of receiving digital multimedia broadcasting, etc., employ electric parts consuming relatively small power thereto. On the other hand, since a processor, which is capable of processing a relatively long wordlength at once, has a relatively high power consumption, requirements of the processor may be different from those of electric parts used in portable apparatuses.

As a more specific example, let's assume that a portable apparatus receiving digital multimedia broadcasting processes a bit sliced arithmetic coding (BSAC) algorithm which is used as a standard for audio signal processes. The BSAC algorithm defines an entropy coding. In the example, let's assume that the entropy coding of the BSAC algorithm is an arithmetic coding of 30 bits.

From such an assumption, a processor of a portable apparatus receiving digital multimedia broadcasting must process operands of over 30 bits at once.

Also, in order to process entropy coding, since the wordlength of operand is greater than processing unit of the processor, if processed bit values are not kept, arithmetic operations cannot be precisely performed.

Since data is processed by processes, such as, encoding and decoding, etc., based on 30 bit values in arithmetic coding of 30 bits, a processor must perform addition, subtraction, and multiplication of 30 bits to perform 30 bit arithmetic coding. Also, buses and memory units must have structures which can use processes over 30 bits.

By the way, if a processor of over 30 bits must be used for only a few arithmetic operations, electric power capacity of a battery must also be relatively increased. Also, structures of buses and memories must be also modified.

Therefore, the related art has a disadvantage in that, in order to process operands of relatively long wordlength, a processor which is capable of processing the bits of wordlength must be used therein, and thus being inefficient.

### SUMMARY OF THE INVENTION

Accordingly, the present invention is directed to a method and apparatus for arithmetic operation of a processor that substantially obviates one or more problems due to limitations and disadvantages of the related art.

An object of the present invention is to provide a method and apparatus for arithmetic operation of a processor which is capable of efficiently performing operations for an operand of relatively long wordlength.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings. To achieve these objects and other advantages and in accordance with the purpose of the invention, in a first aspect of the present invention, a method for an arithmetic operation of a processor comprising the steps of: (a1) dividing a first and a second operands into upper bits and lower bits, respectively, and then storing them, in which each of the first and second operands has wordlength which is greater than wordlength which can be processed by the processor; and (b1) performing an operation of the divided upper bits of the first and second operands, and an operation of the divided lower bits of the first and second operands, respectively.

Preferably, the lower bits of the first operand and the second operand have the same wordlength.

Preferably, the (b1) step further includes the step of: if there is an overflow in the operation result of the lower bits, adding the overflow to the operation result of the upper bits.

Preferably, the method may perform addition for a relatively long wordlength.

In a second aspect of the present invention, a method for an arithmetic operation of a processor comprising the steps of: (a2) dividing a first and a second operands into upper bits and lower bits, respectively, and then storing them therein, in which each of the first and second operands has wordlength which is greater than wordlength which can be processed by the processor; and (b2) subtracting the lower bits of the second operand from the lower bits of the first operand if the upper bits of the first and second operands have the same value.

In a third aspect of the present invention, a method for an arithmetic operation of a processor comprising the steps of: (a3) dividing a first and a second operands into upper bits and lower bits, respectively, and then storing them therein, in which each of the first and second operands has wordlength which is greater than wordlength which can be processed by the processor; (b3) if the upper bits of the first operand is greater than the upper bits of the second operand, subtracting the upper bits of the second operand from the upper bits of the first operand, and then left-shifting the result by the wordlength of the lower bits; and (c3) subtracting the lower bits of the second operand from the operation result in the step (b3), and adding the lower bits of the first operand thereto.

In a fourth aspect of the present invention, a method for an arithmetic operation of a processor comprising the steps of: (a4) dividing a first and a second operands into upper bits and lower bits, respectively, and then storing them, in which each of the first and second operands has wordlength which is greater than wordlength which can be processed by the processor; (b4) if the upper bits of the first operand is smaller than the upper bits of the second operand, subtracting the upper bits of the first operand from the upper bits of the second operand, and then left-shifting the subtraction result by the wordlength of the lower bits; (c4) adding the lower bits of the second operand to the operation result of the step (b4), and subtracting the lower bits of the first operand therefrom; and (d4) taking opposite sign to the result of the step (c4).

In a fifth aspect of the present invention, a method for an arithmetic operation of a processor comprising the steps of: (a5) dividing a first and a second operands into upper bits and lower bits, respectively, and then storing them therein, in which each of the first and second operands has wordlength which is greater than wordlength which can be processed by the processor; (b5) performing a first multiplication between the lower bits of the first operand and the lower bits of the second operand, and a second multiplication between the lower bits of the first operand and the upper bits of the second operand, respectively; and (c5) storing the result of the first multiplication, and the result of the second multiplication, based on the operation results of the step (b5), respectively.

Preferably, the step (b5) further includes the step of adding an overflow to the result of the second multiplication, if the overflow is included in the result of the first multiplication.

In a sixth aspect of the present invention, a method for an arithmetic operation of a processor comprising the steps of: (a6) dividing a first and a second operands into upper bits and lower bits, respectively, and then storing them therein, in which each of the first and second operands has wordlength which is greater than wordlength which can be processed by the processor; (b6) performing a first multiplication between the lower bits of the first operand and the lower bits of the second operand, and a second multiplication between the lower bits of the first operand and the upper bits of the second operand, respectively; (c6) storing the result of the first multiplication, and the result of the second multiplication, based on the operation results of the step (b6), respectively; (d6) performing a third multiplication between the upper bits of the first operand and the lower bits of the second operand, and a fourth multiplication between the upper bits of the first operand and the upper bits of the second operand, respectively; and (e6) storing the result of the third multiplication, and the result of the fourth multiplication, based on the operation results of the step (d6), respectively.

Preferably, the step (b6) further includes the step of adding an overflow to the result of the second multiplication, if the overflow is included in the result of the first multiplication.

Preferably, the step (d6) further includes the step of adding an overflow to the result of the third multiplication, if the overflow is included in the operation result of the adding step.

Preferably, the step (d6) further includes the step of adding an overflow to the result of the fourth multiplication, if the overflow is included in the result of the third multiplication in the step (d6).

In a seventh aspect of the present invention, an apparatus for an arithmetic operation of a processor includes: a memory unit for dividing a first and a second operands into upper bits and lower bits, respectively, and then storing them therein, in which each of the first and second operands has wordlength which is greater than wordlength which can be processed by the processor; an arithmetic and logic unit (ALU) for inputting one or more bits of the upper bits and the lower bits of the first operand, and the upper bits and the lower bits of the second operand, and performing operations therebetween; and an accumulator for storing the operation result of the arithmetic and logic unit (ALU) temporarily.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a schematic block diagram of an apparatus for arithmetic operations of a process according to an embodiment according to the present invention;

FIG. 2 illustrates a flow chart for describing a method for arithmetic operations of a process according to a first embodiment according to the present invention;

FIG. 3 illustrate a flow chart for describing a method for arithmetic operations of a process according to a second embodiment according to the present invention; and

FIG. 4 illustrates a flow chart for describing a method for arithmetic operations of a process according to a third embodiment according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

With reference to attached drawings, preferred embodiments according to the present invention, which can implement the above-mentioned object of the present invention, are described in detail below.

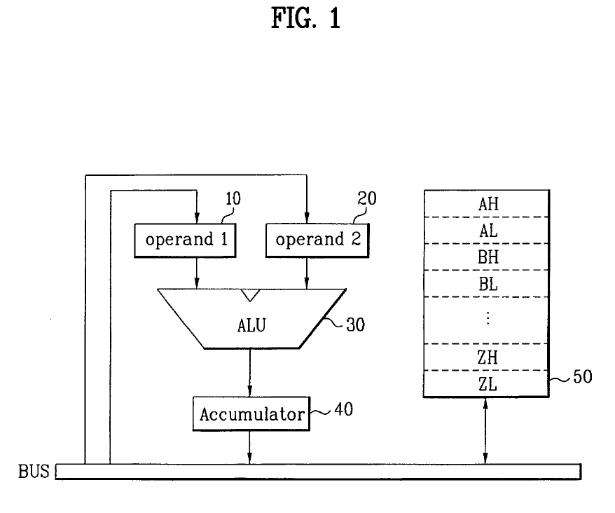

FIG. 1 illustrates a schematic block diagram of an apparatus for arithmetic operations of a process according to an embodiment according to the present invention. As shown in FIG. 1, operations of the apparatus according to the present invention are described as follows.

A memory unit 50 stores data whose wordlength is equal to or less than wordlength unit which can be processed by a processor. Also, a bus can transfer data whose wordlength is equal to or less than wordlength unit which can be processed by the processor.

An ALU 30 inputs a first operand 10 and a second operand 20, respectively. The first operand 10 and second operand are obtained from previous operation results or loaded from the memory unit 50.

The ALU 30 performs an operation of the respective first operand 10 and the second operand 20, and then outputs the operation result thereto. An accumulator 40 accumulates the operation results therein or stores the operation results in the memory unit 50.

The memory unit 50 can be implemented with an internal memory or an external memory of the processor. Also, the memory unit 50 can be implemented to have a single memory structure or multi-memory structure. On the other hand, the bus can be implemented to have a single bus structure or multi-bus structure according to the structure of the memory unit 50.

The arithmetic operation apparatus according to the present invention can properly divide and process operand values whose wordlength is greater than wordlength which can be processed by a processor.

For more easily understanding the present invention, let's assume that a processor having the arithmetic operation apparatus according to the present invention has an internal memory unit, and a 24-bit processor processes an operand whose wordlength is 30 bits.

If there are operands A and B each of which has 30 bits, the operand A is stored in internal memory units, AH and AL, each of which is 24 bits, and the operand B is stored in internal memory units, BH and BL, each of which is 24 bits. Here, AH denotes upper bits of A, and AL denotes lower bits of B. Also, BH denotes upper bits of B, and AL denotes lower bits of B. As such, each of AH, AL, BH and BL has 24 bits or less, which will be adopted as follows.

For example, AH and BH are allocated by an upper 14 bits of A and B, respectively, and AL and BL are allocated by a lower 16 bits of A and B, respectively. When A and B are divided into upper bits and lower bits, respectively, and then stored in the memory units, AH and BH have the same number of bits, and AL and BL have the same number of bits. Here, preferably, the lower bits are set to be higher than the upper bits and then stored therein.

Based on the above-mentioned conditions, the method and apparatus for arithmetic operation of a processor according to the present invention are described in detail below.

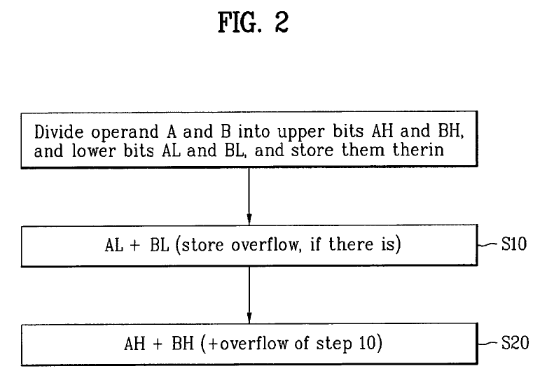

FIG. 2 illustrates a flow chart for describing addition of arithmetic operations of a process according to a first embodiment according to the present invention.

First, when addition for A and B is performed, AL and BL are added, and then an overflow value of the addition result is temporarily stored therein in step S10.

After that, AH and BH are added to each other, and the addition result is added to the overflow in step S20.

If a bit-or operation is performed between the addition result of step S10 and that of step S20, the result A+B can be obtained.

According to the embodiment according to the present invention, although any one of the two operands or two operands are greater than the bit number that can be processed by a processor, such addition can be performed.

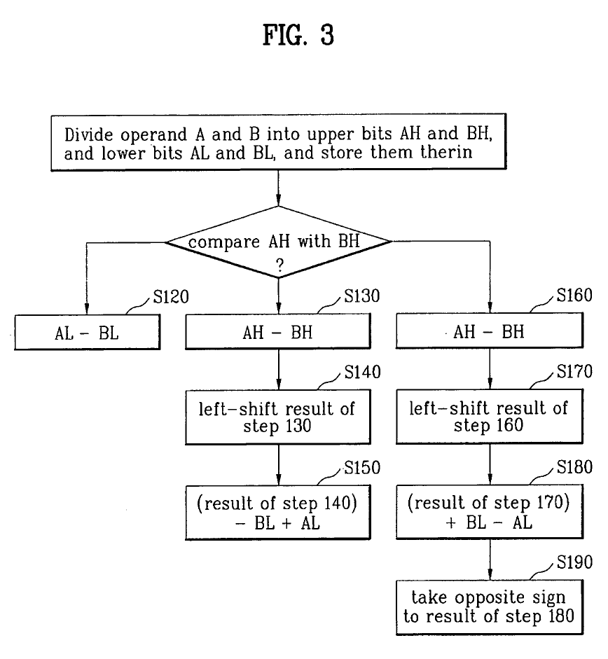

FIG. 3 illustrate a flow chart for describing subtraction of arithmetic operations of a process according to a second embodiment according to the present invention.

When subtraction for a first operand A and a second operand B is performed, AH and BH are compared with their sizes therebetween in step S110.

Based on the size comparison in step S110, if AH and BH are the same in size therebetween, AL is subtracted from BL in step S120. Namely, the subtraction result can be obtained by operation of A-B.

On the other hand, if AH is greater than BH, since operation A-B is (AH+AL)−(BH+BL), the subtraction result can be obtained by operation AH-BH+AL-BL.

Therefore, after performing operation AH-BH in step S130, the operation result is shifted left (or upper bit direction) by the wordlength of AL or BL in step S140.

If AL and BL has the same bit number, size comparison between AH and BH can be easily performed, and operation result of step S160, which will be described later, can be shifted without comparison of the wordlength of AL and BL.

After that, the shifted result is subtracted by BL and then added by AL in step S150.

On the other hand, if BH is greater than AH in step S110, operation BH-AH is performed in step S160. Afterwards, the result value is shifted left (or upper bit direction) by the wordlength of AL or BL in step S170.

After that, the result of step S170 is added by BL and subtracted by AL in step S180. The last operation result is taken by an opposite sign thereof in step S190, thereby obtaining the result of operation A-B.

If the respective steps are processed so as not to obtain negative results, problems, such as sign extension whereby an operation result sign must be additionally designated to the result values, are not generated. On the other hand, when applying an opposite sign to the result value in the final step, the final operation result can be obtained.

According to the embodiment according to the present invention, although any one of the two operands or two operands are greater than the wordlength that can be processed by a processor in one operation cycle, such subtraction can be performed.

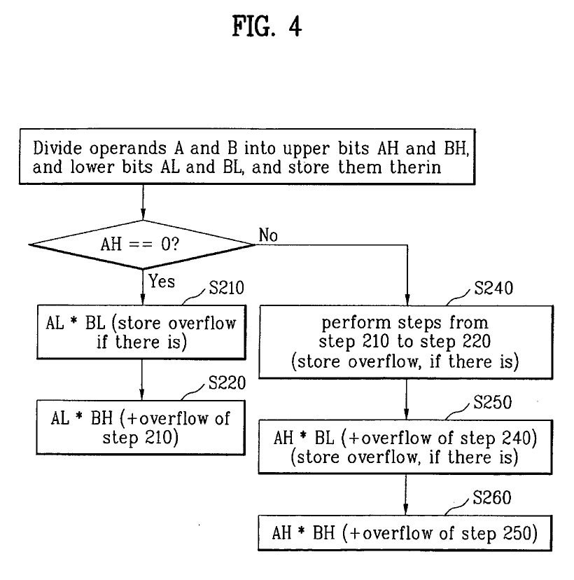

FIG. 4 illustrates a flow chart for describing multiplication of arithmetic operations of a process according to a third embodiment according to the present invention.

Multiplication of operands A and B can be expressed by (AH+AL)*(BH+BL), which is expanded as AH*(BH+BL)+AL*(BH+BL).

Therefore, before performing multiplication, determination as to whether AH is zero is performed in step S200.

If AH is zero, operation AL*BL is performed. After that, the operation result has an overflow, it is temporarily stored therein in step S210.

Afterwards, operation AL*BH is performed. If there is an overflow in step S210, the overflow is added to the result of AL*BH in step S220.

If the result of AL*BL in step S210 and the result in step S220 are performed by bit-or operation, the result A*B can be obtained.

If AH is not zero, operation AL*(BH+BL) is performed through operations from step S210 to step S220. When the operation result has an overflow, it is temporarily stored therein in step S240.

After that, operation AH*BL is performed. The overflow in step S240 is added to the result of AH*BL. Afterward, if the overflow is generated, it is temporarily stored therein in step S250.

Also, operation AH*BH is performed. The overflow in step S250 is added to the result of AH*BH in step S260.

If the result in step S260 and the result in step S230 are processed by bit-or operation, the result of operation A*B can be obtained.

On the other hand, the results of the addition, subtraction and multiplication can be divided into upper bit part and lower bit part for a next operation and then stored therein. Namely, when subtraction is performed after addition or multiplication is performed after subtraction, etc., the results of the operations are divided into the upper bit part (ZH) and the lower bit part (ZL), and then stored therein.

The above-mentioned operation method can efficiently perform operations for operands whose bit number is greater than a bit unit which can be processed a processor, or for operands whose bit number is smaller than the bit unit, in which the latter operands can produce the operation result whose bit number is relatively large.

The method for arithmetic operation according to the present invention can be applied to a universal micro-processor or a digital signal processor (DSP).

As such, the apparatus and method for arithmetic operation of a processor according to the present invention can efficiently process operands whose wordlength is greater than that wordlength which can be processed by a processor at once.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for an arithmetic operation of a processor comprising the steps of:
(a) dividing a first and a second operands into upper bits and lower bits, respectively, and then storing them, in which each of the first and second operands has wordlength which is greater than wordlength which can be processed by the processor; and
(b) performing an operation of the divided upper bits of the first and second operands, and an operation of the divided lower bits of the first and second operands, respectively.

2. The method as set forth in claim 1, wherein the lower bits of first operand and the second operand have the same wordlength.

3. The method as set forth in claim 1, wherein the operations in the step (b) are addition.

4. The method as set forth in claim 3, wherein the (b) step further comprises the step of:
if there is an overflow in the operation result of the lower bits, adding the overflow to the operation result of the upper bits.

5. A method for an arithmetic operation of a processor comprising the steps of:
(a) dividing a first and a second operands into upper bits and lower bits, respectively, and then storing them therein, in which each of the first and second operands has wordlength which is greater than wordlength which can be processed by the processor; and
(b) subtracting the lower bits of the second operand from the lower bits of the first operand if the upper bits of the first and second operands have the same value.

6. The method as set forth in claim 5, wherein the lower bits of the first operand and the second operand have the same wordlength.

7. A method for an arithmetic operation of a processor comprising the steps of:
(a) dividing a first and a second operands into upper bits and lower bits, respectively, and then storing them therein, in which each of the first and second operands has wordlength which is greater than wordlength which can be processed by the processor;
(b) if the upper bits of the first operand is greater than the upper bits of the second operand, subtracting the upper bits of the second operand from the upper bits of the first operand, and then left-shifting the result by the wordlength of the lower bits; and
(c) subtracting the lower bits of the second operand from the operation result in the step (b), and adding the lower bits of the first operand thereto.

8. The method as set forth in claim 7, wherein the lower bits of first operand and the second operand have the same wordlength.

9. A method for an arithmetic operation of a processor comprising the steps of:
(a) dividing a first and a second operands into upper bits and lower bits, respectively, and then storing them, in which each of the first and second operands has wordlength which is greater than wordlength which can be processed by the processor;
(b) if the upper bits of the first operand is smaller than the upper bits of the second operand, subtracting the upper bits of the first operand from the upper bits of the second operand, and then left-shifting the subtraction result by the wordlength of the lower bits;
(c) adding the lower bits of the second operand to the operation result of the step (b), and subtracting the lower bits of the first operand therefrom; and
(d) taking opposite sign to the result of the step (c).

10. The method as set forth in claim 9, wherein the lower bits of the first operand and the second operand have the same wordlength.

11. A method for an arithmetic operation of a processor comprising the steps of:
(a) dividing a first and a second operands into upper bits and lower bits, respectively, and then storing them therein, in which each of the first and second operands has wordlength which is greater than wordlength which can be processed by the processor;
(b) performing a first multiplication between the lower bits of the first operand and the lower bits of the second operand, and a second multiplication between the lower bits of the first operand and the upper bits of the second operand, respectively; and
(c) storing the result of the first multiplication, and the result of the second multiplication, based on the operation results of the step (b), respectively.

12. The method as set forth in claim 11, wherein the lower first operand and the second operand have the same wordlength.

13. The method as set forth in claim 11, wherein the step (b) further includes the step of adding an overflow to the result of the second multiplication, if the overflow is included in the result of the first multiplication.

14. A method for an arithmetic operation of a processor comprising the steps of:
(a) dividing a first and a second operands into upper bits and lower bits, respectively, and then storing them therein, in which each of the first and second operands has wordlength which is greater than wordlength which can be processed by the processor;
(b) performing a first multiplication between the lower bits of the first operand and the lower bits of the second operand, and a second multiplication between the lower bits of the first operand and the upper bits of the second operand, respectively;
(c) storing the result of the first multiplication, and the result of the second multiplication, based on the operation results of the step (b), respectively.
d) performing a third multiplication between the upper bits of the first operand and the lower bits of the second operand, and a fourth multiplication between the upper bits of the first operand and the upper bits of the second operand, respectively; and
(e) storing the result of the third multiplication, and the result of the fourth multiplication, based on the operation results of the step (d), respectively.

15. The method as set forth in claim 14, wherein the step (b) further includes the step of adding an overflow to the result of the second multiplication, if the overflow is included in the result of the first multiplication.

16. The method as set forth in claim 15, wherein the step (d) further includes the step of adding an overflow to the result of the third multiplication, if the overflow is included in the operation result of the adding step of claim 15.

17. The method as set forth in claim 14, wherein the step (d) further includes the step of adding an overflow to the result of the fourth multiplication, if the overflow is included in the result of the third multiplication in the step (d).

18. An apparatus for an arithmetic operation of a processor comprising:
a memory unit for dividing a first and a second operands into upper bits and lower bits, respectively, and then storing them therein, in which each of the first and second operands has wordlength which is greater than wordlength which can be processed by the processor;
an arithmetic and logic unit (ALU) for inputting one or more bits of the upper bits and the lower bits of the first operand, and the upper bits and the lower bits of the second operand, and performing operations therebetween; and
an accumulator for storing the operation result of the arithmetic and logic unit (ALU) temporarily.
